(19) United States
(12) Patent Application Publication
(10) Pub. No.: US 2006/0142954 A1
(43) Pub. Date: Jun. 29, 2006

(54) Device for the determination or monitoring of a physical or chemical process parameter

(75) Inventors: Alexander Muller, Sasbach-Jechtingen (DE); Christoph Rompf, Lorrach (DE)

Correspondence Address: BACON & THOMAS, PLLC, 625 SLATERS LANE, FOURTH FLOOR, ALEXANDRIA, VA, 22314, US

(73) Assignee: ENDRESS + HAUSER GmbH + CO. KG, MAULBURG (DE)

(21) Appl. No.: 10/522,587

(22) PCT Filed: Jul. 18, 2003
(86) PCT No.: PCT/EP03/07844

§ 371 Date: Nov. 21, 2005

(30) Foreign Application Priority Data
Jul. 26, 2002 (EP) 102 34 303.9

(51) Int. Cl. G01N 31/00

(52) U.S. Cl. 702/30

(57) ABSTRACT

The invention relates to a device for the determination or monitoring of a physical or chemical process parameter of a medium with a sensor, a first regulation/analytical unit and a second regulation/analytical unit, whereby each regulation/analytical unit comprises several components. According to the invention, at least one component of each of the first regulation/analytical unit and the second regulation/analytical unit has a redundant and diverse embodiment.

The invention relates to an apparatus for determining and/or monitoring a physical or chemical, process parameter of a medium. The apparatus includes: a sensor; a first control/evaluation unit; and a second control/evaluation unit; with each control/evaluation unit having multiple components. The term “components” with reference to the control/evaluation units is intended to include hardware components as well as software components.

The process parameters to be determined and monitored are, for example, the fill level, flow rate, density, viscosity, pressure, temperature, conductivity, or the chemical composition of the medium. The process parameters are determined using the widest variety of sensors. Measuring devices for determining and monitoring the aforementioned process parameters are sold by the Endress+Hauser group.

Depending on the application, the measuring devices must satisfy the highest safety requirements. As an example, consider fill level monitoring in a tank by means of a limit level detector. If a flammable liquid, or even a non-flammable liquid, but, then, one that is water-endangering, is stored in the tank, then it must be ensured to a high degree that the supply of liquid to the tank is immediately interrupted as soon as the predetermined maximum fill level is attained. This, in turn, assumes that the measuring device is functioning reliably and without error. In order to guarantee this, known solutions provide two sensors working in parallel. As a result of the two-fold layout of the monitoring assembly, the risk of failure is cut in half; on the other hand, costs are doubled.

Furthermore, a failsafe, limit-level switch is known, which is sold by the assignee under the designation “FDL60/FTL670.” This failsafe, limit-level switch is approved as overflow protection for applications with high, and extremely high, safety requirements; that is, in the case of this known limit level switch, it is guaranteed that, in every type of failure and malfunction, it remains in the safe state, or instantaneously transitions into the safe state. This state corresponds e.g. to the closing of the supply valve.

Regular inspection and verification of proper functioning occurs automatically in the case of the known failsafe, measuring device. By redundant construction of the sending/receiving unit, the electronics, and the evaluation unit, as well as by the use of two coded measuring channels, between which a control/evaluation circuit switches back and forth in a predetermined rhythm, errors in the measuring device are recognized with the required high level of safety. A disadvantage of the known solution is that systematic, or systemic, errors inherent in both measuring devices are not discovered. Furthermore, the development of the known solution is very technically challenging, long, and expensive, because during the development process, the occurrence of systematic errors must be prevented or minimized.

An object of the invention is to provide, for use in automation and process measurement technology, an apparatus which distinguishes itself by a high degree of reliability.

This object is achieved by embodying at least one component of the first and second control/evaluation units redundantly and diversely. Through this, a simple possibility is offered to eliminate or minimize systematic errors by a suitable selection of the basic design.

As already mentioned, the components of the control/evaluation unit can involve hardware components or software components. In accordance with a further development of the apparatus of the invention, it is provided that a first microprocessor is assigned to the first control/evaluation unit, and that a second microprocessor is assigned to the second control/evaluation unit. In order to achieve the significant features of the invention, redundancy and diversity, the two microprocessors are, with regard to the hardware components, of different types. An alternative embodiment of the apparatus of the invention provides that the two microprocessors come from two different manufacturers. Additionally or alternatively, it is provided that the relays and/or actuators (e.g. valves) are embodied redundantly and diversely.

In accordance with a preferred embodiment of the apparatus of the invention, the software stored in the microprocessors comes from different sources (manufacturers, programmers). Through this, as well as in the case of the previously described hardware variants, the occurrence of common systematic errors in the supplying of measured values is eliminated. The software variants have the advantage that the only costs which accrue are for the dual construction of the software. Consequential costs—such as are found in the use of redundant hardware components—do not occur.

Of course, both individual, essential hardware components, as well as individual software components, can differ from one another. Through the redundant and diverse design of both hardware and software components, the degree of safety can be still further increased.

Especially, the invention relates to a vibratory detector for determining and/or monitoring the fill level of a medium in a container. Using a modified evaluation algorithm, this kind of detector can also be used for density measurements. Generally, it should be said that the invention is not limited to these explicitly-named applications: In principle, the solution of the invention can be used with the widest variety of measuring devices for measuring any number of different process parameters.

Vibratory detectors constructed as limit switches utilize the effect that the oscillation frequency and the oscillation amplitude of an oscillating element are in each case dependent on the degree of coverage of the oscillating element: While, in air, the oscillating element can execute its oscillations freely and without damping, it undergoes a change in frequency and amplitude as soon as it partially or completely becomes immersed in the medium. On the basis of a predetermined change in frequency (the frequency is typically measured), a definite conclusion can then be drawn concerning attainment of a predetermined fill level of the medium in the container.

Furthermore, the damping of the oscillations of the oscillating element is also influenced by the particular density of the medium. Thus, for constant degree of coverage, there is a functional relationship with the density of the medium, such that vibratory detectors are quite suitable for determining both fill level and density. In practice, for the purpose of monitoring and detecting the fill level and/or density of the medium, the oscillations of the membrane are sensed and converted into electrical, received signals by means of at least one piezoelement.

The electrical, received signals are subsequently evaluated by an evaluation electronics. In the case of determining fill level, the evaluation electronics monitors the oscillation frequency and/or oscillation amplitude of the oscillating element, and signals the conditions “sensor covered” or “sensor uncovered” as soon as the measurement values, respectively, subceed (fall below), or exceed, a predetermined reference value. A corresponding report can be issued to the operator visually and/or acoustically. Alternatively or additionally, a switching operation is initiated; in such case, perhaps a supply valve or drain valve at the container is opened or closed.

For application for fill level monitoring, or fill level detection, as the case may be, the two control/evaluation units, which, according to the invention, are composed of multiple, redundantly and diversely embodied components, determine the reaching of the predetermined fill level.

In accordance with an advantageous embodiment of the limit switch of the invention, the sending/receiving unit is a disc-shaped piezoelectric element, on whose side facing away from the oscillatable unit an electrode structure is provided, which has at least a sending/receiving electrode, a receiving/sending electrode, and a ground electrode. Furthermore, it is provided that the sending/receiving and the receiving/sending electrodes are semi-circular, the ground electrode is bar-shaped, and the sending/receiving electrode and the receiving/sending electrode are arranged mirror-symmetrically with respect to the bar-shaped, centrally-arranged, ground electrode. A corresponding embodiment of a piezo drive for a limit switch is already known from EP 0 985 916 A1. Naturally, other embodiments of the sending/receiving unit can also be used in connection with the apparatus of the invention. Furthermore, the invention can also be structured along the principles of the known, and previously mentioned, failsafe, limit-level detector of the firm Endress+Hauser.

The invention will now be described in greater detail on the basis of the drawing, the sole figure of which shows as follows:

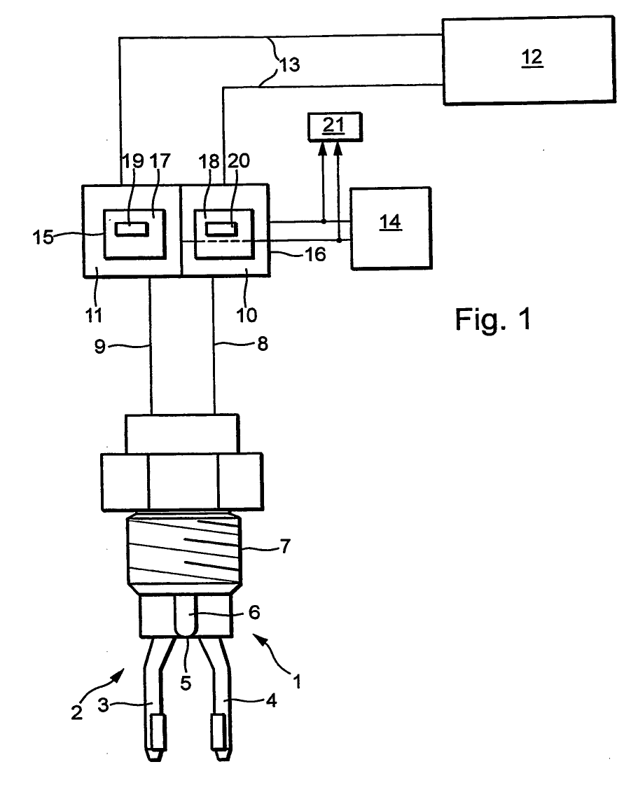

FIG. 1 a schematic illustration of an apparatus 1 of the invention for determining and/or monitoring the fill level of a medium (not shown) in a container (not shown).

The apparatus 1 shown in FIG. 1 is, as already explained above, suitable both for fill level detection and for determining the density of a medium located in a container. While in the case of fill level detection, the oscillatable unit 2 transitions into, or out of, an immersed state upon the reaching of the limit level, it must, in contrast, be continuously immersed in the medium at a predetermined immersion depth h for the purpose of monitoring or determining the density ρ. The container can be, for example, a tank, or a pipe, through which the medium is flowing.

The apparatus 1 has an essentially cylindrical housing. Threads 7 are provided on the exterior surface of the housing. Threads 7 serve for securing the apparatus 1 at the height of a predetermined fill level, by screwing into a corresponding opening of the container. Naturally, other methods of attachment, e.g. by means of a flange, can be substituted for the screwed-connection.

At its end region extending into the container, the housing of the vibratory detector 1 is closed-off by the membrane 5, with the membrane 5 being clamped in its edge region into the housing. The oscillatable unit 2, which extends into the container, is mounted on the membrane 5. In the illustrated case, the oscillatable unit 2 is embodied as a tuning fork, comprising two oscillating tines 3, 4, separated from one another, mounted on the membrane 5, and projecting into the container.

The membrane 5 is caused to oscillate by a drive/receive unit 6, with the drive element being excited to oscillate at a predetermined excitation frequency. The drive element is e.g. a stack drive. Of course, it can also be the disc-shaped piezo drive described above. This so-called bimorph drive is constructed symmetrically: A sending unit is arranged in one semi-circle, and the receiving unit is located in the other semi-circle. Both units are operated alternately as sending and receiving units.

On the basis of the oscillations of the membrane 5, the oscillatable unit 2 also oscillates, with the oscillation frequencies being different, depending on whether the oscillatable unit 2 is in contact with the medium and a coupling to the mass of the medium exists, or, instead, the oscillatable unit 2 is oscillating freely and without contact with the medium. Due to the oscillatory action of the piezoelectric element, the voltage difference leads to a deflection of the membrane 5 clamped into the housing. The oscillating tines 3, 4 arranged on the membrane 5, due to the oscillations of the membrane 5, execute oscillations of opposite sense about their longitudinal axis. Modes with oscillations of opposite sense have the advantage that the alternating forces exerted by each oscillating tine 3, 4 on the membrane 5 mutually cancel. Through this, the mechanical loading of the clamping is minimized, such that essentially no oscillation energy is transferred to the housing, or to the mounting of the vibratory detector. Through this, it is effectively prevented that the mounting means of the vibratory detector 1 are excited to resonance oscillations, which in turn could interfere with the oscillations of the oscillatable unit and corrupt the measurement data.

The electrical, received signals are forwarded to a first control/evaluation unit 10, and to a second control/evaluation unit 11, via data lines 8, 9. In the illustrated case, an error report is transmitted to the operating personnel via the output unit 14. In parallel therewith, the supply valve 21 is closed, when the limit switch is being used as overflow protection. In the case of use of the limit switch as protection against running empty, the pump is shut off. Furthermore, FIG. 1 shows the monitoring or process control station 12, arranged remotely from the vibratory detector 1. The control/evaluation units 10, 11 and the monitoring station 12 communicate with one another via the data line 13. Preferably, because of the heightened interference protection of the transmission, the communication occurs on a digital basis, according to one of the known transmission protocols.

The control/evaluation units 10, 11 can either be housed in the vibratory detector 1, in order to form a compact device, or they can be arranged separately from the actual sensor.

In the illustrated case, each of the control/evaluation units 10, 11 includes a microprocessor 15, 16. Stored in the associated memory units are, among other things, the software programs 19, 20 for evaluating the measurement data and/or for regulating/controlling the sending/receiving unit 6. The microprocessors 15, 16 are either of different types, and/or come from different manufacturers. Alternatively or additionally, the software used in the microprocessors 15, 16 is, at least in the essential components, provided by different programmers. Through the redundant and diverse construction of the control/evaluation units 10, 11, the occurrence of parallel and systematic errors is largely eliminated. Measuring devices constructed in accordance with the invention are thus highly protected against malfunction or failure, such that they are suitable for the most critical of applications.

### LIST OF REFERENCE CHARACTERS

1 vibratory detector, or density sensor
2 oscillatable unit/oscillation element
3 oscillating tine
4 oscillating tine
5 membrane
6 excitation/receiving unit
7 threads
8 data line
9 data line
10 first control/evaluation unit
11 second control/evaluation unit
12 monitoring station
13 data line
14 output unit
15 first microprocessor
16 second microprocessor
17 first memory unit
18 second memory unit
19 first software program
20 second software program
21 valve

1-10. (canceled)

11. The apparatus for determining and/or monitoring a physical or chemical, process parameter of a medium, comprising:
a sensor;
a first control/evaluation unit; and
a second control/evaluation unit; wherein each control/evaluation unit has multiple components, with at least one component of the first and second control/evaluation units being embodied redundantly and diversely.

12. The apparatus as claimed in claim 10, further comprising:
a first microprocessor assigned to said first control/evaluation unit;
a second microprocessor assigned to said second control/evaluation unit, wherein:
said two microprocessors are of different types.

13. The apparatus as claimed in claim 10, further comprising:
a first microprocessor assigned to said first control/evaluation unit;
a second microprocessor assigned to said second control/evaluation unit, wherein:
said two microprocessors come from different sources.

14. The apparatus as claimed in claim 10, wherein:
software stored in said microprocessors comes from different manufacturers.

15. The apparatus as claimed in claim 10, wherein:
the process parameter is one of: fill level, foam formation, flow rate, density, viscosity, pressure, conductivity, and chemical composition of the medium.

16. The apparatus as claimed in claim 10, wherein:
said sensor is a sensor for determining and/or monitoring one of: the fill level of a medium in a container, and for determining the density of a medium in the container.

17. The apparatus as claimed in claim 16, wherein:
said sensor comprises an oscillatable unit, and a sending/receiving unit;
said oscillatable unit is mounted according to one of: at the height of the predetermined fill level, and such that it is immersed in the medium to a defined depth; and
said sending/receiving unit excites said oscillatable unit to oscillate at a predetermined excitation frequency, and receives the response oscillations of said oscillatable unit.

18. The apparatus as claimed in claim 10, wherein:
said two control/evaluation units detect the reaching of the predetermined fill level as soon as a predetermined change in frequency occurs, or, said two control/evaluation units determine the density of the medium on the basis of the oscillation frequency of said oscillatable unit.

19. The apparatus as claimed in claim 17, wherein:
said sending/receiving unit is a disc-shaped piezoelectric element, on whose side facing away from said oscillatable unit an electrode structure is provided, which has at least a sending/receiving electrode, a receiving/sending electrode, and a ground electrode.

20. The apparatus as claimed in claim 19, wherein;
said sending/receiving electrode and said receiving/sending electrode are semi-circular, said ground electrode is bar-shaped, and said sending/receiving electrode and said receiving/sending electrode are arranged mirror-symmetrically with respect to said bar-shaped, centrally-arranged, ground electrode.
